(19) United States
(12) Patent Application Publication
(10) Pub. No.: US 2014/0057987 A1
(43) Pub. Date: Feb. 27, 2014

(54) Disinfectant Spray with Indicator

(71) Applicants: James R. Vinson, Clarksville, TN (US); Phillip G. Pitts, Franklin, TN (US)

(72) Inventors: James R. Vinson, Clarksville, TN (US); Phillip G. Pitts, Franklin, TN (US)

(73) Assignee: GENESIS LABORATORIES, INC., Clarksville, TN (US)

(21) Appl. No.: 13/991,270

(22) PCT Filed: Dec. 5, 2011
(86) PCT No.: PCT/US11/63336

§ 371 Date: Sep. 3, 2013

Related U.S. Application Data
(60) Provisional application No. 61/419,704, filed on Dec. 3, 2010.

(51) Int. Cl. A01N 25/02

(52) U.S. Cl. CPC A01N 25/02; B05B 11/30
USPC 514/635

(57) ABSTRACT

Compositions are provided that comprise a disinfectant, a pH indicator dye, and an alkaline substance. The pH indicator dye expresses a color when initially sprayed, but loses or changes color once sprayed. The compositions may be used to disinfect surfaces, and the pH indicator dye indicates what surface has been disinfected and ensures that a sufficient period of time has passed to disinfect the surface. Dispensing systems that are not fully air tight are provided for containing and dispensing the composition.

### RELATED APPLICATIONS

This application claims priority from U.S. Provisional Application Ser. No. 61/419,704, filed Dec. 3, 2010, the entire disclosure of which is incorporated herein by this reference.

### FIELD OF THE INVENTION

The presently-disclosed subject matter generally relates to compositions comprising a dye that visually disappears upon exposure to a surrounding environment. In particular, the presently-disclosed subject matter relates to a disinfecting germicidal composition comprising a visually disappearing dye, a dispensing system for containing the composition, and methods for making and using the same.

### BACKGROUND OF THE INVENTION

Many people have an aversion to using public surfaces due to the fact that many are not germ free. For example, many have an aversion to public restroom facilities or other objects for personal use which have been used previously by others, which may pose a health risk from contagious germs.

With respect to public restrooms, one of the more commonly available methods for protection is a disposable paper cover for the toilet facility. However, the paper covers do not contain a germicide, may not adequately cover the surface, and are not always available.

A spray germicide for disinfecting surfaces which is quick drying was disclosed in U.S. Pat. No. 3,445,564 to Kirscher. The patent discloses a spray and other alternative embodiments of a quick drying germicide. However, there is no disclosure of use of the disappearing dye which provides a visual assurance and confirmation of the area treated as well as an indicator of germicidal destruction.

The use of a dye in a bactericidal solution was disclosed in U.S. Pat. No. 2,449,274 to Broll. The use of the dye was in a bactericidal liquid to clean objects such as tableware. The solution would change color upon losing bactericidal strength. This was not a surface spray application with a dye indicator.

There are a number of applications for spray germicides such as the commercially available Lysol® spray by Lehn and Fink Products Division of Sterling Drug, Inc. U.S. Pat. Nos. 3,282,776 and 4,201,764 are examples of surface or surface and space spray combinations. None of the patents or products include a dye which is used with the spray in any manner.

Cleaning compositions with disappearing dyes have been attempted in the past. For example, U.S. Pat. Nos. 5,064,635; 5,057,303; 4,965,063; and 4,678,658 to Casey disclose cleaners and disinfectants with dyes. The Casey patents disclose a cleaning composition with a disappearing dye that is packaged in an air-tight container, such as in an aerosol can, in order to avoid the packaged composition from having its dye change or lose its color. The dye is pH sensitive so that upon exposure to air the dye disappears. In the Casey patents, the delivery of the composition gives a visual check as to the surface cleaned. The Casey patents also describe a composition where the basic cleaner product is a mixture of one or more surfactants (detergents) with the pH sensitive dye.

### SUMMARY OF THE INVENTION

Embodiments of the present invention include formulations to safely and conveniently help protect consumers from the daily exposure of bacteria, viruses and fungi. For example, embodiments include a hospital grade, personal disinfectant system that significantly reduces kill times from the industry norm of 10 minutes down to 60 seconds combined with an indicating color to highlight the surface area treated. The indicator eventually disappears or changes color.

Advantages of embodiments of the present invention include that the invention may be contained in a non-air tight container. For example, embodiments of the present invention comprise dispensing systems that utilize an air exchange pump to inject air into the container and dispense a composition. Such designs allow for increased flexibility and ease of use when compared to known dye containing disinfectants.

Embodiments of the present invention are drawn to a composition comprising a disinfectant, an alkaline substance that imparts an alkaline pH to the composition, and about 0.0001 wt % to about 0.01 wt % of a pH indicator dye that visually expresses a color at about the alkaline pH or a higher pH, wherein the pH indicator dye in a container visually expresses the color after air has been injected into the container to dispense a portion of the composition from the container.

In certain embodiments the alkaline substance is NaOH, KOH, or combinations thereof. The pH indicator may be thymolphthalien, bromothyol blue, phenolphthalein, or combinations thereof. The alkaline pH of embodiments of a composition may be about 7.3 or higher, and may be 12.0 to about 12.5.

Embodiments of compositions may further comprise a surfactant.

The disinfectant in certain embodiments of compositions may comprise at least an alcohol, an aldehyde, an oxidizing agent, a phenol, a peroxide, a quat, a hypochlorite, or combinations thereof. The disinfectant may include about 0.5 wt % to about 8.0 wt % hydrogen peroxide, carbamide, urea, or combinations thereof, about 0.5 wt % to about 8.0 wt % aliphatic ethoxylate, about 5.0 wt % to about 20.0 wt % ethanol, and about 0.5 wt % to about 8.0 wt % carbomer.

Other disinfectants in certain embodiments of compositions may comprise about 0.5 wt % to 8.0 wt % benzalkonium, about 0.5 wt % to 8.0 wt % cocamidopropyl betaine, about 0.5 wt % to 8.0 wt % polyquaternium, about 0.5 wt % to 8.0 wt % tetramethylammonium hydroxide, about 0.5 wt % to 8.0 wt % aliphatic ethoxylate, about 5.0 wt % to 20.0 wt % ethanol, and about 0.5 wt % to about 8.0 wt % carbomer.

Further embodiments of compositions may comprise a disinfectant that includes about 0.5 wt % to 8.0 wt % NaOCl, about 0.5 wt % to 5.0 wt % triethanolamine, about 0.5 wt % to 8.0 wt % cocamidopropyl betaine, about 0.5 wt % to 8.0 wt % aliphatic ethoxylate, and about 0.5 wt % to about 8.0 wt % carbomer, and wherein the alkaline substance includes about 0.1 wt % to about 1.0 wt % NaOH. Other specific embodiments may comprise a disinfectant that includes about 10.0 wt % to 80.0 wt % ethanol, propanol, or combinations thereof, about 5.0 wt % to 40.0 wt % water, about 0.2 wt % to 4.0 wt % and biodegradable non-ionic surfactant, about 0.2 wt % to 4.0 wt % anti-corrosive, about 0.2 wt % to 4.0 wt % wetting agent, about 0.2 wt % to 4.0 wt % chlorhexidine gluconate, and about 0.1 wt % to 1.0 wt % propylene glycol.

Still further embodiments of disinfecting compositions may comprise about 10 wt % to about 80 wt % ethanol, propanol, or combinations thereof, about 0.4 wt % to about 4.0 wt % chlorhexidine gluconate, about 0.2 wt % to about 4.0 wt % non-ionic surfactant that includes ethylene oxide, propylene, or combinations thereof, and about 0.0001 wt % to about 0.01 wt % pH indicator dye that visually expresses a color when the composition has an alkaline pH.

Embodiments of the present invention are also drawn to dispensing systems. Specific embodiments of dispensing systems comprise a container suitable for having a composition, and a pump coupled to the container that includes a nozzle and that is in fluid communication with the composition, the pump being configured to dispense the composition from the nozzle by injecting air into the container to displace the composition, wherein the composition includes a disinfectant, an alkaline substance that imparts an alkaline pH to the composition, and about 0.0001 wt % to about 0.01 wt % of a pH indicator dye that visually expresses a color at about the alkaline pH or a higher pH, and wherein the pH indicator dye in the container visually expresses the color after air has been injected into the container to dispense a portion of the composition from the container.

The pump in certain embodiments may include a tube that extends into the container. Pump may be configured to disperse the composition as a fine mist. Also, in embodiments of dispensing systems, air may enter the container only when the composition within the container is dispensed by the pump.

Embodiments of dispensing systems are made of plastic, glass, metal, or combinations thereof, have an internal volume of about 8 mL to about 50 mL, and the air injected into the container contacts the composition within the container. Further embodiments of dispensing systems include a pump that is removably coupled to the container.

Embodiments of the present invention are also drawn to methods for disinfecting a surface, comprising spraying a composition on a surface and allowing sufficient time to pass such that the sprayed composition does not or no longer express a color.

### DESCRIPTION OF DRAWINGS

FIG. 1 shows a cross-sectional view of a pump that can be utilized in embodiments of dispensing systems; and

FIG. 2 shows a cross-sectional view of a pump that can be utilized in embodiments of dispensing systems.

### DESCRIPTION OF EXEMPLARY EMBODIMENTS

The details of one or more embodiments of the presently-disclosed subject matter are set forth in this document. Modifications to embodiments described in this document, and other embodiments, that do not depart from the spirit and scope of the present invention will be evident to those of ordinary skill in the art after a study of the information provided in this document. The information provided in this document, and particularly the specific details of the described exemplary embodiments, is provided primarily for clearness of understanding, and no unnecessary limitations are to be understood therefrom.

While the following terms are believed to be well understood by one of ordinary skill in the art, definitions are set forth to facilitate explanation of the presently-disclosed subject matter.

Unless defined otherwise, all technical and scientific terms used herein have the same meaning as commonly understood by one of ordinary skill in the art to which the presently-disclosed subject matter belongs. Although many methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims. Thus, for example, reference to “a surfactant” includes a plurality of such surfactants, and so forth.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration, or percentage is meant to encompass variations in some embodiments of ±20%, in some embodiments of ±10%, in some embodiments of ±5%, in some embodiments of ±1%, in some embodiments of ±0.5%, and in some embodiments of ±0.1% from the specified amount, as such variations are appropriate to perform the disclosed method. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

A disinfectant must sufficiently cover a surface for a period of time a surface to disinfect the surface. Thus, one must ensure that a surface has been fully contacted with disinfectant and a sufficient amount of time has passed for the disinfectant to effectively remove infectious agents or slow their rate of growth. Embodiments of the present invention comprise a disinfecting composition that includes a pH indicator dye. When the disinfecting composition is applied to a surface it initially expresses a color. The pH of composition changes once the composition is exposed to the surface and the surrounding environment. Embodiments of the present invention are designed so that as the pH changes, it enters a range wherein the pH indicator dye no longer expresses a color. Furthermore, certain embodiments of compositions transition from expressing a color to not expressing a color in a time period that is sufficient for the disinfectant to effectively remove infectious agents or slow their rate of growth. Thus, embodiments of the present invention allow users to visually ensure that they have sufficiently covered a surface and that enough time has passed for it to be disinfected.

The term “composition”, as used herein in reference to embodiments of the present invention, is used to refer to a composition that comprises a disinfectant, an alkaline substance that imparts an alkaline pH to the composition, and a pH indicator dye. The alkaline substance may or may not be included as part of the disinfectant. This composition generally visually expresses a color when in a container, but once it is applied to a surface the pH changes so that the dye no longer expresses a color.

The term “disinfectant”, as used herein, is used to refer to a component of the composition that provide antimicrobial, microbiocidal, or similar activity. Generally, a disinfectant helps remove or eliminate infectious agents and/or slow their rate of growth. A disinfectant may exhibit anti-germ action against particular organisms, including those discussed throughout this document. Examples of disinfectants include, but are not limited to, alcohols, aldehydes, oxidizing agents, phenolic compounds, peroxides, quats, and the like. Disinfectants may also comprise a plurality of components, some or all of which having disinfecting characteristics. Any disinfectant known in the art that meets the needs of a particular circumstance may be used in embodiments of the present invention.

The term “alkaline substance”, as used herein, has the same meaning as in the relevant art. Specifically, alkaline substance is used to generally refer to substances that have a basic character, including soluble bases. In certain embodiments, the alkaline substance will impart an alkaline pH to a composition. Examples of alkaline substances include, but are not limited to sodium hydroxide (NaOH) and potassium hydroxide (KOH). Any alkaline substance known in the art may be used with embodiments of the present invention. However, it is preferable that the alkaline substance not interfere with the function of the disinfectant and be safe for use on surfaces, skin, or the like, as required by specific embodiments of the present invention.

The term “alkaline pH”, as used herein, has the same meaning as it generally does in the relevant art. In certain embodiments alkaline pH may correspond to a pH of about 6 to about 14, including about 7, 9, 10, 11, 12, or 13, and any pH therebetween. In certain embodiments the alkaline pH will cause a pH indicator dye to visually express a color.

The terms “pH indicator dye”, “pH indicator”, or “dye”, as used herein, refer to a substance that visually expresses a color in a certain pH range and a different or no color when outside of that pH range. Certain pH indicators described herein visually express a color when exposed to an alkaline pH or higher. Certain pH indicators described herein may also express a color when below an alkaline pH, but eventually express a different or no color once the pH has been sufficiently lowered. Examples of dyes that are used in certain embodiments include thymolphthalein, bromothyol blue, and phenol phenolphthalein.

The term “visually express” or “express”, as used herein, refers to being visually observable by the naked eye. For example, a dye that expresses a color is a dye that has a color that can be seen by the naked eye. There is no limitation on the colors that may be expressed.

The term “container”, as used herein, refers to any vessel or similar object that has a cavity suitable for housing a composition. A container may be of any shape, size, material, color, and the like that meets the needs of a particular circumstance. Containers may comprise additional features such as, but not limited to, handles and screw openings for receiving a cap or pump. A container may have an internal volume that is equivalent to the volume of fluid it can contain.

The term “dispense”, as used herein, refers generally to the ejection of a composition from a container or dispensing system. The dispensing may be, for example, accomplished by using a air exchange pump, opening, or the like. There is no limitation on the amount or manner in which a composition is dispensed. In certain embodiments a composition may be dispensed as a fine mist that resembles an aerosolized spray, which may be accomplished by using, for example, a nozzle or atomizer. In other embodiments the composition may be dispensed as a single stream of liquid, as drops, under high or low pressure, and so forth. Any form of dispensing that meets the needs of a particular circumstance may be utilized in embodiments of the present invention.

The term “pump”, as used herein, refers to a device that is capable of dispensing a composition that is located within a container. The pump may be an “air-exchange” pump that functions by injecting air or the like into the container. The injected air then displaces and dispenses some or all of the composition within the container. The amount of composition dispensed depends on the amount of air injected and amount of composition within the container. More specifically, a pump may inject air into a container and dispense the composition out of a nozzle or other opening.

Pumps may be designed in any manner that meets the limitations of a composition and container, and that dispenses the composition in a desired fashion. Furthermore, pumps may include a tube that extends into the container, thereby facilitating the pumps' ability to dispense the liquid. Those of skill in the art will appreciate that a pump, including the optional tube, nozzle, and the like, may be in fluid communication with a composition within a container. Pumps may also be designed to be “removably coupled” to a container, meaning that it can be detached and reattached one or more times from the container.

The term “gel”, as used herein, has no set definition but generally refers to a substance that is more viscous and retains its shape for a longer period of time than a liquid or paste. Generally, a gel will not be as firm as a wax or similar substance. Gels may have a viscosity that permits them to be dispensed, as defined above.

A specific embodiment of the present invention comprises a composition that includes a disinfectant, an alkaline substance, and a pH indicator dye. This composition has superior and unexpected results over prior compositions. For example, embodiments of the composition have a ratio of components that allows the dye in a container to visually express a color even after air has been injected into the container to dispense a portion of the liquid. Embodiments of this novel and nonobvious composition may therefore be used in a multitude of containers, and not just fully air-tight containers, such as traditional aerosol containers. For example, embodiments of the composition may be used in a container having an air-exchange pump, and the air injected into the container by the air-exchange pump will not hinder the dye in the composition from expressing a color.

This design allows for a broad variety of containers to be used to house the composition, allowing for flexibility and the ability to work effectively for a variety of applications. By not requiring traditional aerosol air-tight containers, embodiments of the composition may be packaged in containers that are more suitable for air travel, personal hand held use, instances where the noise of an aerosol spray is undesirable, and the like.

Any suitable disinfectant may be used with embodiments of compositions so long as they do not interfere with the dye, including its color, and other aspects of a composition. Disinfectants may be of a medical grade and be acceptable for use in medical facilities, such as hospitals and doctors' offices. In specific embodiments of the present invention, the chemical ingredients, and particularly the disinfectant, may be obtained from Micrylium Laboratories (Toronto, Canada).

Embodiments of the present invention can be used for disinfecting many different surfaces or materials from glass, porcelain, metals, and plastics to skin to any surface requiring protection from germs. For example, embodiments of the present invention are effective against at least salmonella, staph, e-coli, tuberculosis, pneumonia, HIV-1, hepatitis-B, poliovirus and canine parvovirus in less than one minute.

Certain embodiments of the present invention are hard surface disinfectant sprays. Specific embodiments disinfect to an Environmental Protection Agency (“EPA”) standard in 60 seconds in only one step, which means no pre-cleaning of a surface is necessary as with the case with most mass market surface cleaners. When sprayed, specific embodiments of the present invention turn the surface blue, and usually within 60 seconds the blue color disappears leaving a disinfected surface. The blue color is achieved by the use of a pH indicator, such as thymolphthalein or bromothymol blue, for example. Embodiments of compositions are alkaline and may be stored inside a container having an air-exchange pump. In such embodiments, when the product is sprayed or dispensed, the mixture interacts with the atmosphere which makes the composition migrate to a neutral pH. This causes the blue color on sprayed surfaces to disappear over time. The color serves as an indicating color for the spray to help the user by providing visual confirmation of what surfaces have been sprayed.

The mechanism by which a composition's pH adjusts so that a dye transitions from expressing a color to expressing no or a different color depends on the specific composition utilized and the environment in which it was sprayed. Without being bound my theory or mechanism, embodiments of alkaline compositions generally experience a color change when sprayed in air because of the neutralization of the composition from CO₂ in the air, which is acidic. Taking such factors into consideration permits compositions to be adjusted to change color at desired rates in particular environments. The rate of color change may be affected by, among other things, the type and concentration of pH indicator dye in a composition.

In embodiments of the present invention, by simply lightly spraying the product over the areas to be disinfected, a colored mist will appear on the surfaces. The visual color disappears and dries in 10 to 60 seconds. In other specific embodiments the color disappears in 30 to 60 seconds. In still further embodiments the visual color disappears and dries in over 60 seconds.

Embodiments of the present invention offer effective virus and bacteria strain kill times, and its indicating, non-stain pH indicator color allows users to recognize treated areas and the composition making it safer for the environment. Competitors market effectiveness of their products within a 10 minute treatment time frame only after pre-cleaning the surface. Embodiments of the present invention disinfectant surfaces in about 60 seconds with no pre-cleaning required.

Specific embodiments of the present invention are also safer disinfectants because, unlike other disinfectants, the they are not manufactured with potentially harmful chemicals and agents. For examples, embodiments of the present invention contain no phenols, which are carcinogenic, butyl cellusolve, which is a neurogenic, or aldehydes. Thus, embodiments of the present invention may effectively disinfect a surface without exposing the user or others to harmful chemicals. Because certain embodiments of the present invention are free from toxic chemicals typically used in other spray and wipe germicides or disinfectants, gloves and masks may not be necessary when using embodiments of the present invention. These embodied compositions are non-toxic to humans and animals, do not irritate skin, and therefore also offer the advantage of being more easily and safely applied that other disinfectants.

Furthermore, for all embodiments the presence of a pH indicator dye allows one to confirm if surfaces are unintentionally are covered by the composition. Thus, a further advantage of embodiments of the present invention is that a user may avoid unintentionally spraying surfaces, and, due to the dye in the composition, may easily visualize and clean any surfaces that should not come in contact with the composition.

The chart below outlines specific bacteria strain kill times using certain embodiments of the present invention:

| | Effective | |
|---|---|---|
| Strain | Contact Time | Germicidal Spray |
| Salmonella choleraesuis | 20 Seconds | The Present Invention Spray, |
| | | AOAC protocol |
| Pseudomonas aeruginosa | 20 Seconds | The Present Invention Spray, |
| | | AOAC protocol |
| Staphylococcus aureaus | 20 Seconds | The Present Invention Spray, |
| | | AOAC protocol |
| Trichophyton | 20 Seconds | The Present Invention Spray, |
| mentagrophytes | | AOAC protocol |
| Mycobacterium | 50 Seconds | The Present Invention Spray, |
| smegmatis TB | | AOAC protocol |
| Canine Parvovirus | 50 Seconds | The Present Invention Spray, |
| | | AOAC protocol |
| Human | 20 Seconds | The Present Invention Spray, |
| Immunodeficiency | | AOAC protocol |
| Virus type 1 | | |
| Hepatitus B virus | 40 Seconds | The Present Invention Spray, |
| | | AOAC protocol |

As a further example, certain embodiments of the present invention utilize bromothyol blue or thymolphthalein as a dye. These pH indicator dyes, as of the filing date of this application, are on the EPA approved inert list. Thus, embodiments of the present invention comply with certain government regulations, making them suitable for a broader array of applications.

Embodiments of the present invention comprise: between 10 to 80 wt % of an alcohol solution, such as ethanol, propanol, the like, or a combination thereof; between 0.4 to 4.0 wt % of chlorhexidine gluconate; between 0.2 to 4.0 wt % of a non-ionic surfactants including ethylene oxide and/or propylene; and between 0.0001 to 0.01 wt % thymolphthalein or another pH indicator dye.

Embodiments may comprise any amount of pH indicator dye that imparts the desired color to a composition and allow the composition to express a color for a desired amount of time after being sprayed. Generally, compositions will comprise 0.1 wt % or less of pH indicator dye. Other embodiments may comprise 0.0001, 0.0002, 0.0003, 0.0004, 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, or 0.1 wt % of pH indicator dye.

Another embodiment of a composition includes the following formulation:

| | |
|---|---|
| Ethanol, Propanol, Ethanol, or combinations thereof | 10 to 80% |
| Purified Water: | 5.0 to 40% |
| Biodegradable Non-Ionic Surfactants: | 0.2 to 4.0% |
| Anti-Corrosives: | 2.0 to 4.0% |
| Wetting Agents | 0.2 to 4.0% |
| Chlorhexidine Gluconate | 0.2 to 4.0% |
| Propietary Polymers | 0.2 to 4.0% |
| Propylene Glycol | 0.1 to 1.0% |
| Scents | 0.1 to 1.0% |
| pH Indicator Dye (e.g. Bromothymol or | 0.0001 to .01% |
| Thymolphthalein) | |

In further embodiments, the liquid surface disinfectant is BioSURF (Micrylium; Toronto, Canada), which comprises 70.5 wt % ethanol anhydrous and 0.2 wt % chlorhexidine gluconate. BioSURF had been recognized for its significant virucidal treatment of Hepatitis B in 40 seconds and HIV in 20 seconds.

Chlorhexidine gluconate, is the primary compound in certain embodiments of the present invention. While chlorhexidine gluconate is an antiseptic with a broad spectrum of bacterial and fungal kill capabilities, it has never before been incorporated into a composition comprising a pH indicator dye that facilitates the ability for a user to effectively apply the composition. Furthermore, embodiments comprising clorhexidine gluconate may have the advantage of possessing a residual disinfecting effect on surfaces.

A still further embodiment of a composition that is a peroxide comprises:

| | |
|---|---|
| Hydrogen (or Carbamide, Urea) | 0.5% to 8.0% |
| Peroxide | |
| Aliphatic Ethoxylate | 0.5% to 8.0% |
| Ethanol | 5% to 20.0% |
| Phenolphthalein or Thymolphthalein | 0.0001% to 0.01% (e.g. 0.001%) |
| Carbomer | 0.5% to 8.0% |

A further embodiment of a composition that is quat comprises:

| | |
|---|---|
| Benzalkonium Chloride | 0.5% to 8.0% |
| Cocamidopropyl betaine | 0.5% to 8.0% |
| Polyquaternium | 0.5% to 8.0% |
| Tetramethylammonium Hydroxide | 0.5% to 8.0% |
| Aliphatic Ethoxylate | 0.5% to 8.0% |
| Ethanol | 5.0% to 20.0% |
| Carbomer | 0.5% to 8.0% |
| Phenolphthalein or Thymolphthalein | 0.0001% to 0.01% (e.g. 0.001%) |

A specific embodiment that includes a hypoclorite comprises:

| | |
|---|---|
| NaOCl | 0.5% to 8.0% |
| Triethanolamine | 0.5% to 5.0% |
| Cocamidopropyl betaine | 0.5% to 8.0% |
| Aliphatic Ethoxylate | 0.5% to 8.0% |
| Carbomer | 0.5% to 8.0% |
| Phenolphthalein or Thymolphthalein | 0.0001% to 0.01% (e.g. 0.001%) |
| NaOH | 0.01% to 1.0% |

As discussed above, embodiments of compositions may comprise any single or combination of suitable pH indicator dyes. The following is a non-limiting list of pH indicator dyes that may be used in conjunction with embodiments of the present invention:

| | Low | Transition | High |
|---|---|---|---|
| Indicator | pH color | pH range | pH color |
| Gentian violet(Methyl violet 10B) | yellow | 0.0-2.0 | blue-violet |
| Leucomalachite green(first | yellow | 0.0-2.0 | green |
| transition) | | | |
| Leucomalachite green(second | green | 11.6-14.0 | colorless |
| transition) | | | |
| Thymol blue(first transition) | red | 1.2-2.8 | yellow |
| Thymol blue (second transition) | yellow | 8.0-9.6 | blue |
| Methyl yellow | red | 2.9-4.0 | yellow |
| Bromophenol blue | yellow | 3.0-4.6 | purple |
| Congo red | blue-violet | 3.0-5.0 | red |
| Methyl orange | red | 3.1-4.4 | orange |
| Bromocresol green | yellow | 3.8-5.4 | blue |
| Methyl red | red | 4.4-6.2 | yellow |
| Methyl red | red | 4.5-5.2 | green |
| Azolitmin | red | 4.5-8.3 | blue |
| Bromocresol purple | yellow | 5.2-6.8 | purple |
| Bromothymol blue | yellow | 6.0-7.6 | blue |
| Phenol red | yellow | 6.8-8.4 | red |
| Neutral red | red | 6.8-8.0 | yellow |
| Naphtholphthalein | colorless to | 7.3-8.7 | greenish |
| | reddish | | to blue |
| Cresol Red | yellow | 7.2-8.8 | reddish- |
| | | | purple |
| Phenolphthalein | colorless | 8.3-10.0 | fuchsia |
| Thymolphthalein | colorless | 9.3-10.5 | blue |
| Alizarine Yellow R | yellow | 10.2-12.0 | red |
| Litmus | red | 4.5-8.3 | blue |

Without being bound by theory or mechanism, surfactants may increase the rate at which embodiments disinfect. For example, embodiments comprising SurfOL surfactant (Micrylium; Toronto, Canada) have been found to eliminate undesired organisms at a faster than prior compositions having pH indicator dye. The surfactants utilized may be linear alkyl ethoxlylates, which may biodegrade within 13 days. Furthermore, certain embodiments may utilize USP grade consumable ethanol, which is considered to be absolute pharmaceutical grade.

Disinfectants utilized in embodiments of present invention exhibit numerous superior and unexpected advantages over prior compositions and dispensing devices. First, certain embodiments of the present invention disinfect well in heavy blood and protein environments, and may be effective against mature pellicle colonies of pseudomonas sp. Certain embodiments will not corrode metals, stain, or stick as do water-based chlorine, chlorhexidine, or iodine containing compositions. Embodiments of disinfectants may contain no surfactants based on nonylphenyl ethoxylates, which may have negative health implications and, for example, disrupt hormone balances.

Certain embodiments may further comprise a fragrance so that a disinfected surface or skin has a scent after having been disinfected with the composition.

As discussed herein, embodiments of the represent invention comprise a dispensing system for dispensing a disinfecting composition that comprises a pH indicator dye. Embodiments of dispensing systems may utilize an air exchange pump to dispense a composition, which offers superior and unexpected advantages over prior designs. For example, because the container is not airtight, for example like a aerosol container, the composition within the system does not need to be placed under pressure.

Embodiments of dispensing systems are also highly flexible in their design, and can be designed to meet users' needs to a greater extent than air tight containers can. One design advantage is that dispensing systems comprising a pump be refilled with composition without unduly affecting the effectiveness of the pH indicator dye contained therein. For example, once a user has consumed a container of composition, the user may remove a pump or cap from the container and then either refill the same container with fresh composition or place the pump or cap on another container that has composition. Therefore, the ability to expose the composition to a certain amount of air before it loses its color also allows for increased reusability and customizability of the dispensing systems.

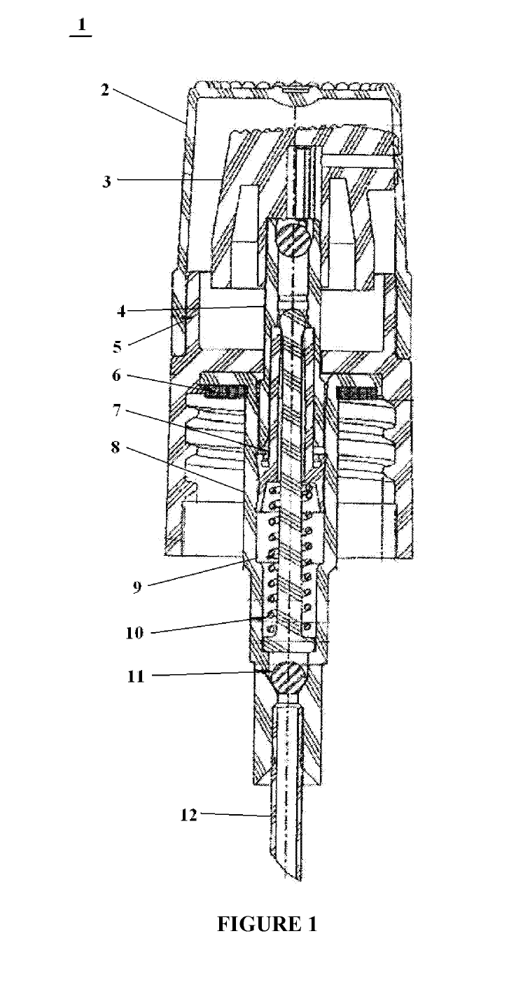

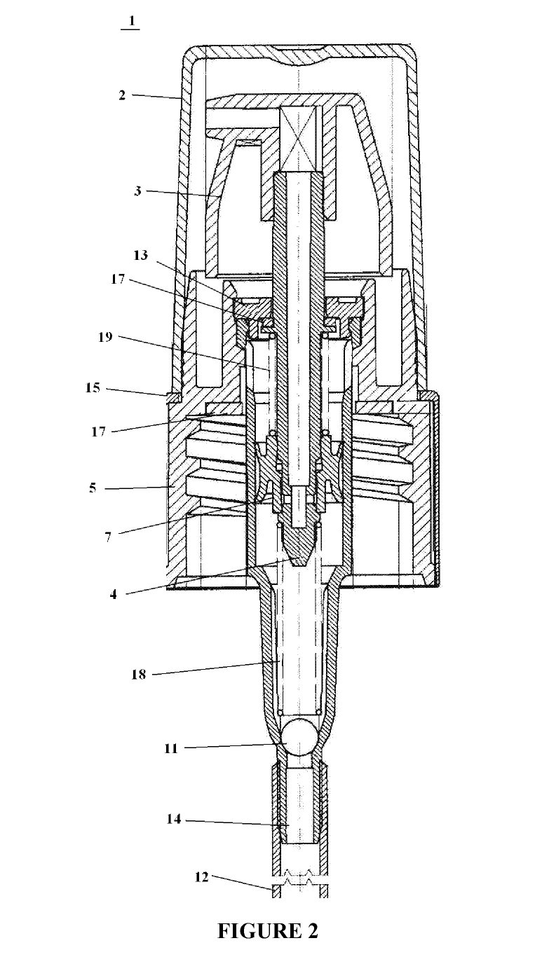

Embodiments include an air-exchange sprayer (pump) that utilizes outside atmosphere to be brought into the container to force out a metered amount of spray with each pump. Pumps that are utilized in specific embodiments are shown in FIGS. 1 and 2. FIGS. 1 and 2 depict a cross-sectional views of embodied pumps 1. The pumps 1 may comprise a dust cap 2, an actuator 3, a stem 4, a closure 5, a gasket 6, a piston 7, a tank 8, a poppet 9, a spring, 10, a ball 11, a dip tube 12, a retainer 13, housing 14, a collar 15, an inner gasket 16, an outer gasket 17, a long spring 18, and a short spring 19. These embodied pumps spray a composition from a container by injecting air into the container. The pumps are relatively air tight when they are not being used to dispense a composition, in part because they utilize a ball 11 to block off a container from its exterior environment when not spraying a composition.

Embodiments of the present invention include various methods of packaging and various packaging sizes. Specific embodiments of dispensing systems comprise a 50 mL container and an air exchange pump that dispenses a composition by injecting air into the container. Similar embodiments may include 8 mL containers. Of course, any volume container may be utilized that meets the limitations of a particular circumstance. Therefore, embodiments of the present invention can be packaged in non-aerosol form and in amounts less that 2 oz. or 3 oz., enabling easy carry on for airplanes.

For examples, embodiments of dispensing systems may contain 5 mL, 10 mL, 15 mL, 20 mL, 25 mL, 30 mL, 35 mL, 40 mL, 45 mL, 50 mL, 60 mL, 70 mL, 80 mL, 90 mL, 100 mL, 150 mL, 200 mL, 250 mL, 300 mL, 350 mL, 400 mL, 500 mL, 600 mL, 700 mL, 800 mL, 900 mL, or 1000 mL. Other embodiments may contain more than 1000 mL.

Embodiments of the present invention may be used as needed, including for public and private schools, restaurants, child booster seats, child diaper changing stations, shopping malls, theaters, daycare centers, taxi cabs, cell phones, computer keyboards, and other areas where microbial disinfection is desired to prevent or hinder infection.

For comparative purposes, below is a chart of current surface disinfectants. The disinfectants listed below all have an EPA certified disinfectant kill time of more than four minutes. On the other hand, embodiments of the present invention have the superior and unexpected advantage of having an disinfectant kill time of less than 60 seconds, which when coupled with a pH indicator dye that disappears in 60 seconds or less, allows a user to effectively apply and monitor the disinfectant.

| | Active | Disinfecting | |
|---|---|---|---|
| Product | Ingredients | Instructions | Sanitizing Instructions |
| Embodiments | Ethanol Anhydrous | No pre-cleaning required. | |
| of the present | 70.5%; Chlorhexidine | Spray on surface and let | |
| invention | Gluconate 0.2% | stand for 60 seconds. | |
| Lysol | Active Ingredients: | For pre-cleaned surfaces, | Let stand for 30 seconds |
| Disinfectant | Alkyl (50% C14, 40% | let stand for 10 minutes to | then rinse thoroughly. |
| Spray To Go | C12, 10% C16) | air dry. Rinse with water | |
| | Dimethyl Benzyl, | on food contact surfaces | |
| | Ammonium | and toys. | |
| | Saccharinate 0.10%, | | |
| | Ethanol 58.00% | | |
| Mr. Clean | Octyl Decyl Dimethyl | Allow surface to remain | NA |
| Wipes | Ammonium Chloride | wet for 10 minutes | |
| | 0.069%, Dioctyl | | |
| | Dimethyl Ammonium | | |
| | Chloride 0.028%, | | |
| | Didecyl dDmethyl | | |
| | Ammonium Chloride | | |
| | 0.042%, Alkyl (C14, | | |
| | 50%; C12, 40%; C16, | | |
| | 10%)-Dimethyl | | |
| | Benzyl Ammonium | | |
| | Chloride 0.093% | | |
| Lysol | Alkyl (50% C14, 40% | Surface must remain | Surface must remain |
| Disinfecting | C12, 10% C16) | visibly wet for 10 | visibly wet for 30 |
| Wipes | Dimethyl Benzyl | minutes. | seconds. |
| | Ammonium Chlorides | | |
| | 0.32% | | |
| Lysol Neutra | Triethylene Glycol | Allow to stand for 10 | Allow to stand for 5 |
| Air Sanitizing | 5.40% Alkyl (50% C14, | minutes to air dry. Rinse | minutes then rinse with |
| Spray | 40% C12, 10% C16) | with water on food | potable water. |
| | Dimethyl Benzyl | contact surfaces. | |
| | Ammonium | | |
| | Saccharinate 0.05% | | |
| Lysol | Alkyl (67% C12, 25% | Let stand for 10 minutes | NA |
| Disinfectant | C14, 7% C16, 1% C8-C10-C18) | before wiping. | |
| Antibacterial | Dimethyl | | |
| Kitchen | Benzyl Ammonium | | |
| Cleaner | Chlorides 0.08% Alkyl | | |
| | (50% C14, 40% C12, | | |
| | 10% C16) Dimethyl | | |
| | Benzyl Ammonium | | |
| | Chlorides 0.02% | | |
| Oust Surface | Triethylene Glyco | Spray pre-cleaned hard, | Spray pre-cleaned hard, |
| Disinfectant | 6.0%, n-Alkyl (40% | non-porous surface until | non-porous surface until |
| & Air | C12, 50% C14, 10% | wet. Allow product to | wet. Allow product to |
| Sanitizer | C16) Dimethyl Benzyl | remain on surface 5 | remain on surface 30 |
| | Ammonium | minutes. | seconds. |
| | Saccharinate 0.2% | | |
| Windex | L-Lactic Acid 0.18% | Spray surface until | Spray surface until |
| Antibacterial | | thoroughly wet. Allow | thoroughly wet. Let stand |
| Multi-surface | | surface to remain wet for | 10 seconds then wipe. |
| | | 5 minutes then wipe. | |
| Clorox | n-Alkyl (C14, 60%; | Surface must remain | Surface must remain |
| Disinfecting | C16, 30%; C12, 5%; | visibly wet for 4 minutes. | visibly wet for 30 |
| Wipes | C18, 5%) Dimethyl | | seconds. |
| | Benzyl Ammonium | | |
| | Chloride 0.145%, n- | | |
| | Alkyl (C12, 68%; C14, | | |
| | 32%) Dimethyl | | |
| | Ethylbenzyl | | |
| | Ammonium Chloride | | |
| | 0.145% | | |
| Clorox | Sodium Hypochlorite | NA | Spray on surface until |
| Anywhere | 0.0095% | | thoroughly wet. Let stand |
| Hard Surface | | | for 2 minutes. |
| Daily | | | |
| Sanitizing | | | |
| Spray | | | |
| Fantastik | n-Alkyl (60% C14, 30% | NA | Spray until wet. Let stand |
| Oxypower | C16, 5% C12, 5% C18) | | 10 seconds then wipe. |
| Multi- | Dimethyl Benzyl | | |
| Purpose | Ammonium Chlorides | | |
| Cleaner | 0.11% n-Alkyl (68% | | |
| | C12, 32% C14) | | |
| | Dimethyl Ethylbenzyl | | |
| | Ammonium Chlorides | | |
| | 0.11% | | |

As described above, numerous benefits will result from employing the concepts of embodiments of the present invention, including certain compositions and dispensing systems.

### EXAMPLES

The following non-limiting examples represent descriptions of certain embodiments of the present invention that are meant to serve illustrative purposes and that shall not limit the present invention in any manner.

### Example 1

This Example is a preferred dispensing system. A 50 mL container that includes an opening surrounded by a threaded portion is provided (Baralan International S.p.a.; Milano, Italy; Art. 74298). The container is filled with 50 mL of a composition. The composition comprises 99.999 wt % of BioSURF (Micrylium Laboratories; Toronto, Canada), 0.001 wt % thymolphthalein, and an amount of an alkaline substance sufficient to impart a pH of 12.0-12.5 to the composition.

The container is then coupled to an air exchanger pump (ABA Packaging Corp.; Holtsville, N.Y.; ABA18/15DSTW & ABA18/15DSTG). The pump comprises a dust cover (Part No. 19-32-07), an actuator (Part No. 19-72-08), a stem (Part No. 19-23-01), a closure (Part No. 19-04-15), a gasket (Part No. 19-30-XX) a piston (Part No. 19-07-01), a tank (Part No. 19-62-03), a poppet (Part No. 19-02-01), a spring (19-50-01), a ball (Part No. 19-93-01), and a dip tube (Part No. 19-82-03). In this embodiment, the pump dispenses the composition by injecting air into the container, which in turn exerts a pressure upon and displaces the composition within the container.

### Example 2

This Example is a preferred dispensing system for dispensing an embodiment of a composition that is a gel and that may be used as, among other things, a hand sanitizer. A 50 mL container that includes an opening surrounded by a threaded portion is provided (Baralan International S.p.a.; Milano, Italy; Art. 74298). The container is filled with 50 mL of a composition. The composition comprises 99.999 wt % of BioSURF (Micrylium Laboratories; Toronto, Canada), 0.001 wt % bromothymol blue, and an amount of an alkaline substance sufficient to impart a pH of 12.0-12.5 to the composition.

The container is then coupled to an air exchanger pump (ABA Packaging Corp.; Holtsville, N.Y.; ABAL18/15DSTS). The pump comprises a dust cap, an actuator, a retainer, an inner gasket, a short spring, a collar, an outer gasket, a closure, a piston, a stem, a long spring, a ball, housing, and a dip tube. In this embodiment, the pump dispenses the composition by injecting air into the container, which in turn exerts a pressure upon and displaces the composition within the container.

This application references various patents and/or publications. All such patents and/or publications are expressly incorporated herein by reference in their entirely.

1. A composition, comprising:
a disinfectant;
an alkaline substance that imparts an alkaline pH to the composition; and
about 0.0001 wt % to about 0.01 wt % of a pH indicator dye that visually expresses a color at about the alkaline pH or a higher pH.

2. The composition of claim 1, wherein the alkaline substance is NaOH, KOH, or combinations thereof.

3. The composition of claim 1, wherein the pH indicator is thymolphthalien, bromothyol blue, phenolphthalein, or combinations thereof.

4. The composition of claim 1, wherein the alkaline pH is about 7.3 or higher.

5. The composition of claim 4, wherein the alkaline pH is about 12.0 to about 12.5.

6. The composition of claim 1, further comprising a surfactant.

7. The composition of claim 1, wherein the disinfectant includes an alcohol, an aldehyde, an oxidizing agent, a phenol, a peroxide, a quat, a hypochlorite, or combinations thereof.

8. The composition of claim 1, wherein the disinfectant includes:
about 0.5 wt % to about 8.0 wt % hydrogen peroxide, carbamide, urea, or combinations thereof;
about 0.5 wt % to about 8.0 wt % aliphatic ethoxylate;
about 5.0 wt % to about 20.0 wt % ethanol; and
about 0.5 wt % to about 8.0 wt % carbomer.

9. The composition of claim 1, wherein the disinfectant includes:
about 0.5 wt % to 8.0 wt % benzalkonium;
about 0.5 wt % to 8.0 wt % cocamidopropyl betaine;
about 0.5 wt % to 8.0 wt % polyquaternium;
about 0.5 wt % to 8.0 wt % tetramethylammonium hydroxide;
about 0.5 wt % to 8.0 wt % aliphatic ethoxylate;
about 5.0 wt % to 20.0 wt % ethanol; and
about 0.5 wt % to about 8.0 wt % carbomer.

10. The composition of claim 1, wherein the disinfectant includes:
about 0.5 wt % to 8.0 wt % NaOCl;
about 0.5 wt % to 5.0 wt % triethanolamine
about 0.5 wt % to 8.0 wt % cocamidopropyl betaine;
about 0.5 wt % to 8.0 wt % aliphatic ethoxylate; and
about 0.5 wt % to about 8.0 wt % carbomer; and
wherein the alkaline substance includes about 0.1 wt % to about 1.0 wt % NaOH.

11. The composition of claim 1, wherein the disinfectant includes:
about 10.0 wt % to 80.0 wt % ethanol, propanol, or combinations thereof;
about 5.0 wt % to 40.0 wt % water;
about 0.2 wt % to 4.0 wt % and biodegradable non-ionic surfactant;
about 0.2 wt % to 4.0 wt % anti-corrosive;
about 0.2 wt % to 4.0 wt % wetting agent;
about 0.2 wt % to 4.0 wt % chlorhexidine gluconate; and
about 0.1 wt % to 1.0 wt % propylene glycol.

12. A disinfecting composition, comprising:
about 10 wt % to about 80 wt % ethanol, propanol, or combinations thereof;
about 0.4 wt % to about 4.0 wt % chlorhexidine gluconate;
about 0.2 wt % to about 4.0 wt % non-ionic surfactant that includes ethylene oxide, propylene, or combinations thereof; and
about 0.0001 wt % to about 0.01 wt % pH indicator dye that visually expresses a color when the composition has an alkaline pH.

13. A disinfectant dispensing system, comprising:
a container suitable for housing a composition; and
a pump coupled to the container that includes a nozzle and that is in fluid communication with the composition, the pump being configured to dispense the composition from the nozzle by injecting air into the container to displace the composition;
wherein the composition includes:
a disinfectant;
an alkaline substance that imparts an alkaline pH to the composition, and
about 0.0001 wt % to about 0.01 wt % of a pH indicator dye that visually expresses a color at about the alkaline pH or a higher pH.

14. The disinfectant dispensing system of claim 13, wherein the pump includes a tube that extends into the container and is in fluid communication with the composition.

15. (canceled)

16. The disinfectant dispensing system of claim 13, wherein air enters the container only when the composition within the container is dispensed by the pump.

17. The disinfectant dispensing system of claim 13, wherein the container is made of plastic, glass, metal, or combinations thereof.

18. The disinfectant dispensing system of claim 13, wherein the container has an internal volume of about 8 mL to about 50 mL.

19. The disinfectant dispensing system of claim 13, wherein the air injected into the container contacts the composition within the container.

20. The disinfectant dispensing system of claim 13, wherein the pump is removably coupled to the container.

21. A method for disinfecting a surface, comprising:
spraying the composition of any of claim 1 on a surface; and
allowing sufficient time to pass such that the sprayed composition does not express a color.

22. The composition of claim 13, wherein the pH indicator dye in the container visually expresses the color after air has been injected into the container by the pump.

23. The disinfectant dispensing system of claim 13, wherein the alkaline substance is NaOH, KOH, or combinations thereof.

24. The disinfectant dispensing system of claim 13, wherein the pH indicator is thymolphthalien, bromothyol blue, phenolphthalein, or combinations thereof.

25. The disinfectant dispensing system of claim 13, wherein the alkaline pH is about 7.3 or higher.

25. The disinfectant dispensing system of claim 13, wherein the disinfectant includes a surfactant, an alcohol, an aldehyde, an oxidizing agent, a phenol, a peroxide, a quat, a hypochlorite, or combinations thereof.
